(19) United States
(12) Patent Application Publication
(10) Pub. No.: US 2025/0289662 A1
(43) Pub. Date: Sep. 18, 2025

(54) Vehicle System and Vehicles Therefore

(71) Applicant: ABB Schweiz AG, Baden (CH)

(72) Inventor: Haayo Terpstra, Apeldoorn (NL)

(73) Assignee: ABB Schweiz AG, Baden (CH)

(21) Appl. No.: 19/222,191

(22) Filed: May 29, 2025

Related U.S. Application Data
(63) Continuation of application No. PCT/EP2022/083703, filed on Nov. 29, 2022.

(51) Int. Cl. B65G 1/06; B25J 5/00

(52) U.S. Cl. CPC B65G 1/065; B25J 5/007

(57) ABSTRACT

A vehicle system includes a movable platform, a container, a robot mounted on the platform, a first support for the container within reach of the robot, and at least one second support for the container. The platform includes a horizontal conveyor configured to swap the container between the first and second supports via a first path, and an elevator configured to swap the container between the first and second supports via a second path above the first path, wherein the second path comprises an apex position that is high enough above the first path for the container to be swapped along the first path when a similar container is at the apex position.

### CROSS-REFERENCE TO RELATED APPLICATIONS

The instant application claims priority to International Patent Application No. PCT/EP2022/083703, filed Nov. 29, 2022, which is incorporated herein in its entirety by reference.

### FIELD OF THE DISCLOSURE

The present disclosure generally relates to a vehicle system for handling objects and, more particularly, to a vehicle system for picking and/or handling fruit.

### BACKGROUND OF THE INVENTION

There have been various proposals for robotic fruit picking systems. Recognizing fruit ripe for picking and automatically finding the movements to be executed by a robot in order to reach a ripe fruit and pick it is still a challenging task for modern computers, so that the robot still needs much more time for picking a given quantity of fruit than a human worker. Nevertheless, the use of robots for picking fruit is attractive since if human labor is not available in sufficient amount when the fruit is ripe, e.g. for political or epidemiological reasons, the harvest may be lost.

Slowness of a fruit picking robot can be made up by low operating cost per time. So the robot can just be placed next to a plant to be harvested, together with a container to put the fruit in, be allowed the time it needs to pick the fruit in its reach, eventually replacing the container when full. The space available for replacing the container is limited by the distance between rows of plants, typically of trees in an orchard. In most modern plantations, this distance is just wide enough to allow the containers used for harvesting the fruit, typically pallet boxes of EUR 1 or EUR 2 type, to be moved between the rows. For the economic viability of fruit picking by robot, it is therefore a key issue to allow handling of such containers within the limited space between two rows of trees.

### BRIEF SUMMARY OF THE INVENTION

The embodiments in accordance with the present disclosure provide a vehicle system comprising a movable platform, at least one container, an object-handling robot mounted on said platform, the platform further comprising a first support for the container within reach of the robot and at least one second support for the container, characterized in that the platform comprises a horizontal conveyor adapted to swap the container between said first and second supports via a first path, and an elevator adapted to swap the container between said first and second supports via a second path above the first path, wherein the second path comprises an apex position that is high enough above the first path for the container to be swapped along the first path when a similar container is at the apex position. By raising one container while another swaps positions by passing underneath the lifted container, a full container can be taken out of reach of the robot and replaced by an empty one in a space that is not substantially wider than the containers themselves.

The height to which one container must be raised in the apex position depends on the type of container used. Containers of EUR 1 or EUR 2 type come in different heights that will be chosen depending on the softness of the fruit to allow swapping places of large boxes, the apex position should be at least 80 cm above the first path.

Of course, the vehicle system of the invention might be used for handling other types of objects but fruit. The handling may comprise not only collecting the objects into the container but also distributing objects from the container.

According to one embodiment, the movable platform comprises a first vehicle and a second vehicle removably connected to the first vehicle by a hitch, wherein the first support and the robot are is on the first vehicle and the second support is on the second vehicle. The two-part structure would allow the second vehicle, eventually carrying a full container, to be moved away from the robot and to replace it by a second vehicle carrying an empty box, whereas the first vehicle remains in place, and the robot can continue its work, filling a box next to it. While the two vehicles are coupled by the hitch, the distance between first and second supports is limited, facilitating the swapping of containers.

Since the robot is operable without the second vehicle in place next to it, one second vehicle can be used for servicing a plurality of first vehicles. In a system where one second vehicle is associated to a plurality of first vehicles, cost can be reduced by providing the elevator on the second vehicle.

For moving a container along the second path, the elevator can comprise at least one telescopic arm pivotally mounted on the platform, optionally on the second vehicle. Preferably, two such arms can be provided on either side of the platform.

The conveyor can be divided into a first conveyor section on the first vehicle and a second conveyor section portion on the second vehicle.

Where the hitch provides at least one rotational degree of freedom between the first and second vehicles, the first and second conveyor sections are preferably aligned in parallel when the first and second vehicles are in a straight configuration. The platform will assume the straight configuration when moving along a straight path such as along a corridor between two rows of trees, so that wherever the platform may stop next to a tree, containers can be swapped.

Typically, the first conveyor section comprises at least two first rails parallel to each other and the second conveyor section comprises second rails parallel to each other, allowing a container to be moved from the first support to the second initially along the first rails, then along the second. Preferably, in a configuration where the first rails are parallel to the second rails, each second rail is laterally offset with respect to the first rails. Thus, a gap between first and second conveyor sections can be made small without the freedom of rotation of the hitch being reduced by first and second rails abutting each other.

At least the second vehicle should comprise a motor for locomotion for removing a full container and bring an empty one while the robot remains in place. Of course, the first vehicle can also comprise a motor, to enable it to move from one tree to the next when work on one has been finished.

Either vehicle can be adapted for autonomous navigation or for remote control by a central computer coordinating all vehicles of the system.

In a further aspect, the present disclosure describes a vehicle for use as the first vehicle in the vehicle system described above, comprising a first carriage, an object-handling robot mounted on said carriage, and the carriage further comprising a first support for a container within reach of the robot.

The vehicle may further comprise a first conveyor section for conveying a container to and from the first support.

The disclosure also relates to a vehicle for use as the second vehicle in the vehicle described above, comprising a second carriage, a second support for a container, a second conveyor section and an elevator for lifting a container from said second support.

Either vehicle may be adapted for autonomous navigation.

### BRIEF DESCRIPTION OF THE SEVERAL VIEWS OF THE DRAWING(S)

FIG. 1 is a schematic view of the vehicle system in which the robot is discharging picked fruit into a container in accordance with the disclosure.

FIG. 2 is an overall view of the vehicle system in a first phase of a container swapping process in accordance with the disclosure.

FIG. 3 is an overall view of a second phase of the container swapping process in accordance with the disclosure.

FIG. 4 is an overall view of a third phase of the container swapping process in accordance with the disclosure.

FIG. 5 is an overall view of the vehicle system in which the second vehicle is removing a full container in accordance with the disclosure.

FIG. 6 is a plan view of two vehicles from above in accordance with the disclosure.

FIG. 7 is an outline view of a vehicle system in accordance with the disclosure.

### DETAILED DESCRIPTION OF THE INVENTION

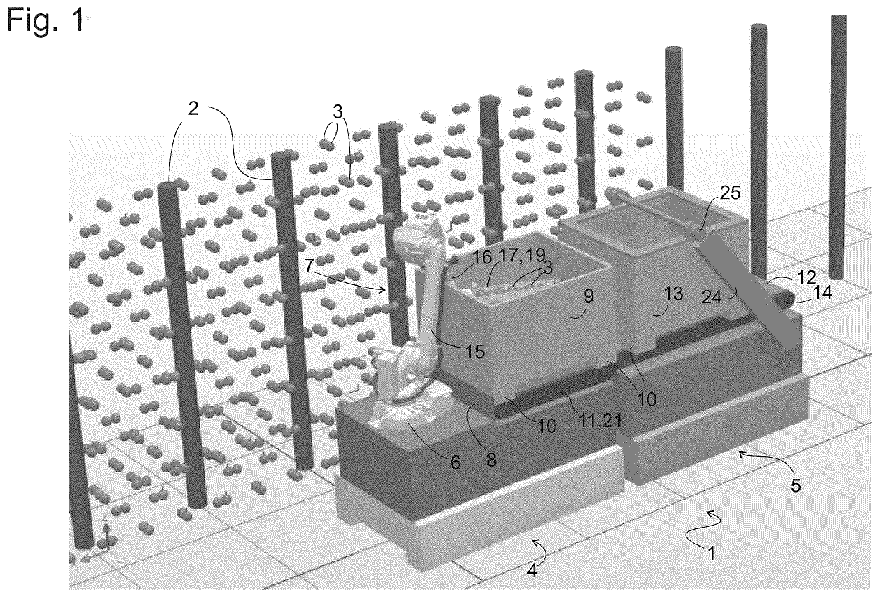

FIG. 1 is a schematic view of the vehicle system 1 of the present invention in front of a row of trees 2 bearing fruit 3 to be picked. The vehicle system 1 comprises first and second vehicles 4, 5, preferably one or both being AGVs (autonomous guided vehicles), which are sized and designed to be autonomously movable in a corridor between rows of trees planted in parallel, as usual in commercial orchards. Carriage bodies of the vehicles 4, 5 can have wheels or crawler tracks, not shown. In the configuration of FIG. 1, the two vehicles 4, 5 are coupled by a hitch, not shown.

On a top side of the first vehicle 4 carriage body 4′ there is a base 6 of an articulated robot 7, and, adjacent to the base 6, a support 8 for a box in which to collect the fruit. The support 8 is shaped for locking engagement with a conventional pallet box 9 of EUR 1 or EUR 2 type, i.e. having a length of 1.2 m and a width of 0.8 m or 1.0 m, respectively. To prevent the box 9 from falling off the first vehicle 4, locking engagement, at least in a transversal direction of vehicle 4, is ensured by feet 10 of the box 9 extending downwards on both sides of a first conveyor section 11. In the longitudinal direction, a bottom of the box 9 may just be in frictional engagement with endless belts of the conveyor section 11, or the belts can have a profile for locking engagement with the bottom of the box 9.

Similarly, the second vehicle 5 is provided with a support 12 for a second box 13, of a design identical to box 9. The support 12 comprises a second conveyor section 14 engaging the bottom of box 13.

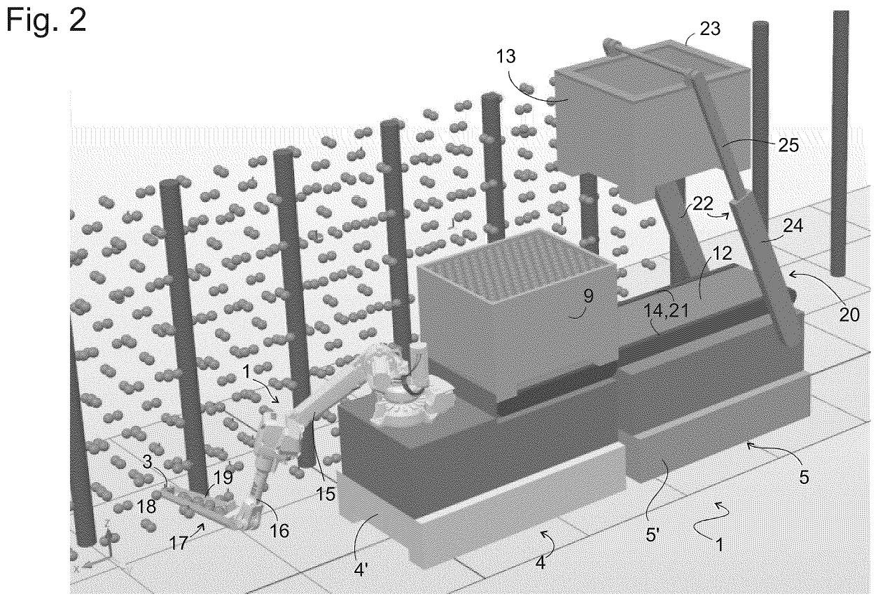

The articulated robot 7 comprises a proximal link 15 which is free to pivot with two degrees of rotational freedom relative to base 6, a distal link 16 having one degree of rotational freedom relative to proximal link 15, and an end effector 17 which has three degrees of rotational freedom relative to the distal link 16. The end effector 17 is shown in FIG. 1 in the process of releasing picked fruit 3 into the box 9. The end effector 17 has a gripper 18 (see FIG. 2) for detaching fruit 3 from a tree 2 at a distal end thereof, and an elongate storage bay 19 between the gripper 18 and the distal link 16 that can be turned over or opened at the bottom in order to release the picked fruit 3. Design and operation of the end effector 17 are described in detail in PCT/EP2021/076397, which is incorporated herein in its entirety by reference. The storage bay 19 should be sized to accommodate several pieces of fruit 3 at a time.

FIG. 2 shows the robot 1 in the process of picking fruit 3. The box 9 behind the robot 1 is full and cannot receive the fruit 3 currently held in storage bay 19. Therefore the box 9 must be replaced by empty box 13. When the process of replacing the boxes 9, 13 is begun just after a last storage bay full of fruit has been emptied into box 9 and box 9 has been found to be full, the time the robot 1 needs for returning from the box 9 to the tree 2 and filling the storage bay 19 with fruit once more can be used for replacing the boxes 9, 13 without having to interrupt the picking process.

For the boxes 9, 13 to swap places, box 13 has been raised by an elevator 20 from support 12 to an apex position where the bottom of box 13 is higher than an upper side of box 9. With the box 13 in this position, the support 12 can be seen from above. The support 12 comprises rails 21 that form part of the second conveyor section 14, for guiding a movement of a box in the longitudinal direction of vehicle 5. Typically, there are two rails 21 in a symmetrical arrangement. In the embodiment shown, each rail 21 comprises a motorized endless belt extending in the longitudinal direction of vehicle 5 around sprockets, not shown, at both face sides of the vehicle 5.

The elevator 20 comprises two arms 22 pivotably mounted on vehicle 5 on either side of support 12, and a frame 23 mounted between upper ends of the two arms 22. The frame 23 is releasably engaged with an upper edge of box 13. The length of the arms 22 is variable, preferably and as shown, by each arm 22 comprising telescopically engaging sections 24, 25. In FIG. 1, distal section 25 is nearly fully retracted into proximal section 24; in FIG. 2, a large part of it protrudes from proximal section 24.

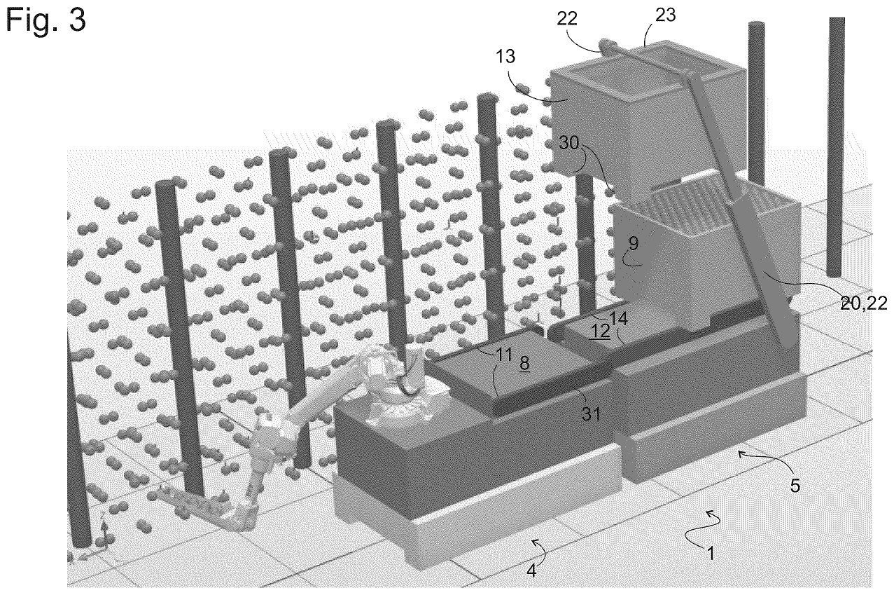

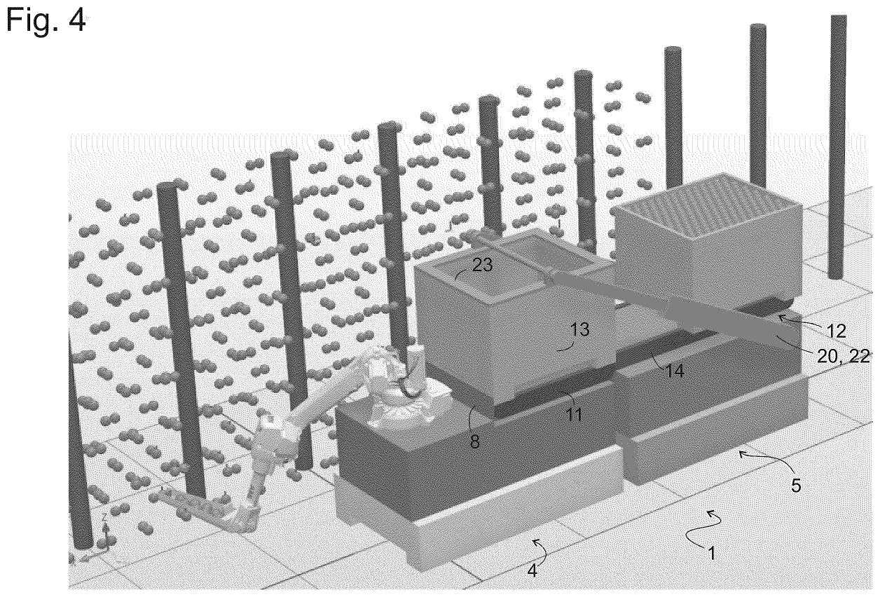

By operating conveyor sections 11, 14, box 9 is moved along a substantially horizontal first path from vehicle 4 to support 12 of vehicle 5, as shown in FIG. 3. By tilting forward the arms 22 of elevator 20, box 13 is lowered from the apex position and is placed on support 8, as shown in FIG. 4.

The feet 10 on opposite sides of box 13 can have inner sides that converge towards each other in the upward direction. Similarly, lateral flanks 31 of support 8 that face these inner sides 30 can be convergent in the upward direction. Either measure facilitates the placing of box 13 on the support 8, since a misalignment between the two will be corrected by the inner sides 30 and the flanks 31 gliding along each other while the box 13 is being lowered.

Frame 23 is then detached from box 13, and the elevator 20 moves back towards the position it had in FIG. 1, whereby frame 23 comes to engage the upper edge of box 9 on support 12.

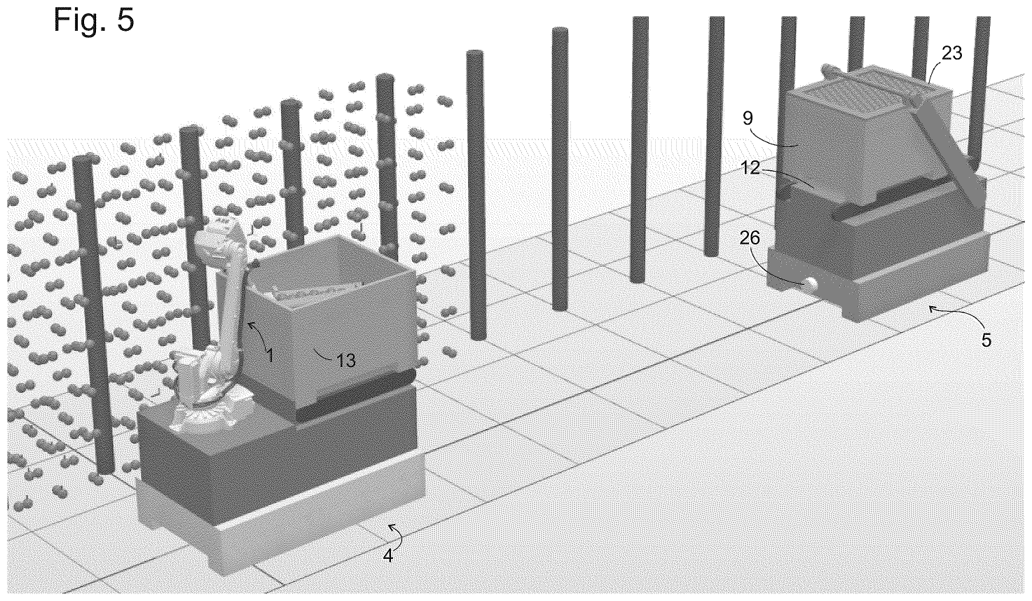

FIG. 5 shows the robot 1 of vehicle 4 filling the new box 13, and vehicle 5 moving away from vehicle 4 while carrying the full box 9. On a face side of vehicle 5, part of a hitch 26 is schematically shown, which is coupled to a complementary hitch part of vehicle 4 at least in the process of exchanging boxes 9, 13, to hold the two vehicles 4, 5 are at a constant, predetermined distance.

The box 9 is stabilized by engagement of the frame 23, so that it cannot fall off the support 12 even when the vehicle 5 is moving in uneven terrain.

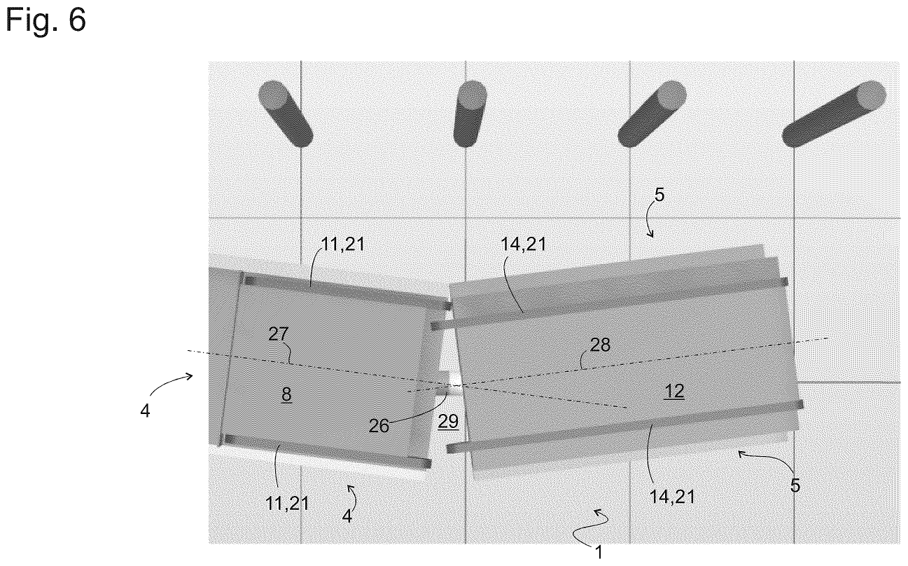

FIG. 6 is a top view of the rear part of vehicle 4 and vehicle 5, showing the conveyor sections 11, 14, and the hitch 26 connecting the two vehicles 4, 5 in an atypically twisted configuration, i.e. in a configuration in which an angle between longitudinal axes 27, 28 of the vehicles 4, 5 is unusually large. Like a towing hitch in a car, the hitch 26 can comprise a ball connected to one of the vehicles 4, 5 and a cavity for engaging the ball, connected to the other vehicle 5, to hold the vehicles 4, 5 at a predetermined distance while allowing one to rotate relative to the other in yaw, pitch and roll degrees of freedom. Part of the wall of the cavity is displaceable by an actuator controlled by the vehicle 4 or 5 carrying the cavity, allowing the vehicles 4, 5 to be autonomously coupled for the process of exchanging boxes and to be uncoupled so that vehicle 5 can move off with a full box and return with an empty one.

In a preferred embodiment, the hitch 26, in its coupled state, also provides for an electrical connection between the vehicles 4, 5. By this connection, a battery of vehicle 5 can be used for recharging a battery of vehicle 4 that powers the robot arm 1. Whenever a vehicle 5 moves away with a full box 9 and returns with an empty one, it can also bring fresh electrical power which, via the electrical connection, can be transferred to a battery of vehicle 4, thereby enabling the robot 7 to work without interruption and without having to return to a charging station for a much longer time than would correspond to the capacity of the built in battery of vehicle 4.

Rails 21 of both conveyor sections 11, 14 are parallel to the longitudinal axes 27, 28 of their respective vehicles 4, 5. Hitch 26 allows the vehicles 4, 5 to assume a configuration in which, seen from above as in FIG. 6, the longitudinal axes 27, 28 intersect. In order to reduce a distance across gap 29 between the two vehicles 4, 5 in which box 9 is not supported while being moved from vehicle 4 to vehicle 5, the rails 21 of at least one of conveyor sections 11, 14 protrude beyond a face side of their respective vehicle 4 or 5 into gap 29. Since the rails 21 of conveyor section 14 are laterally offset relative to those of conveyor section 11, misalignment between the longitudinal axes 27, 28 can become so large that rails 21 of the different sections 11, 14 overlap in their longitudinal direction. But they do not collide, allowing a safe transfer of box 9 between the vehicles 4, 5 by means of the conveyor sections 11, 14 even when their respective longitudinal axes 27, 28 are far from parallel.

Any misalignment between the vehicles 4, 5 can also pose a problem when the elevator 20 is to deposit its box 13 on support 8. To align the box 13 with the longitudinal direction 27 of vehicle 4 when placing it on support 8, lengths of the two arms 22 can be adapted to be controlled independently from one another.

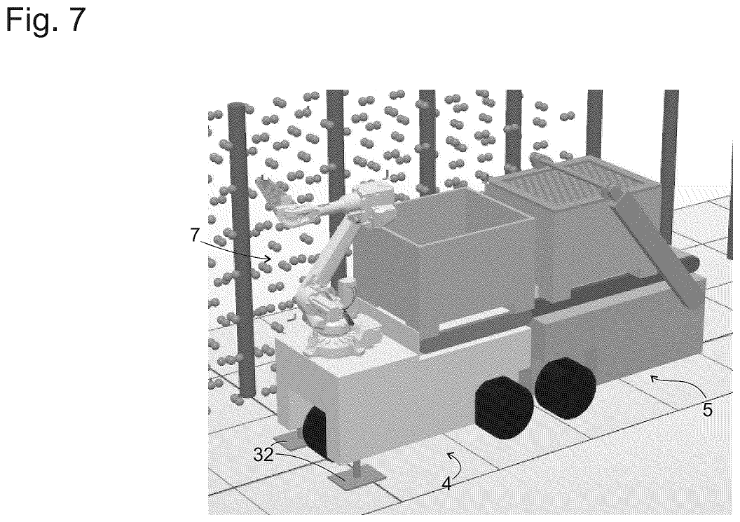

While a yaw misalignment as shown in FIG. 6 can only be reduced by both vehicles 4, 5 advancing along a straight line, roll and pitch misalignments can be corrected without the vehicles 4, 5 moving, but by providing one of the vehicles 4, 5 with extendable stabilizers 32 as shown in FIG. 7, typically at corners of a carriage body facing away from the other vehicle. By pressing these stabilizers 32 against the ground to a varying extent using actuators, vehicle 4 can adapt its orientation to that of vehicle 5 so that first and second supports 8, 12 extend in parallel planes, and the transfer of boy 9 to vehicle 5 can be carried out smoothly. Stabilizers 32 are preferably provided on vehicle 4, since there they can also help to stabilize the robot arm 7 in the picking process.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A vehicle system, comprising:
a movable platform;
at least one container;
an object-handling robot mounted on the movable platform, the moveable platform further comprising a first support for the at least one container within reach of the object-handling robot and at least one second support for the at least one container;
wherein the platform further comprises:
a horizontal conveyor configured to swap the at least one container between the first and second supports via a first path; and
an elevator configured to swap the at least one container between the first and second supports via a second path disposed above the first path;
wherein the second path comprises an apex position that is disposed sufficiently high enough above the first path to fit the at least one container to be swapped along the first path and pass below a second container disposed at the apex position along the second path.

2. The vehicle system of claim 1, wherein the at least one container is a pallet box.

3. The vehicle system of claim 1, wherein the object-handling robot is configured to collect fruit.

4. The vehicle system of claim 1, wherein the movable platform further comprises a first vehicle and a second vehicle removably connected to the first vehicle by a hitch.

5. The vehicle system of claim 4, wherein the first support and the object-handling robot are on the first vehicle and the second support is on the second vehicle.

6. The vehicle system of claim 4, wherein the second vehicle comprises the elevator.

7. The vehicle system of claim 4, wherein the hitch is configured to provide at least one rotational degree of freedom between the first and second vehicles.

8. The vehicle system of claim 4, further comprising an electrical connector between first and second vehicles.

9. The vehicle system of claim 8, wherein a battery of the first vehicle is adapted to be recharged via the electrical connector.

10. The vehicle system of claim 4, wherein the horizontal conveyor comprises a first conveyor section disposed on the first vehicle and a second conveyor section disposed on the second vehicle.

11. The vehicle system of claim 10, wherein the first and second conveyor sections are aligned in parallel when the first and second vehicles are in a straight configuration.

12. The vehicle system of claim 11, wherein the first conveyor section comprises at least two first rails parallel to each other and the second conveyor section comprises at least two second rails parallel to each other, and wherein in a configuration where the first rails are parallel to the second rails, each second rail is laterally offset with respect to the first rails.

13. The vehicle system of claim 1, wherein the elevator comprises at least one telescopic arm pivotally mounted on the platform.

14. The vehicle system of claim 2, wherein at least the second vehicle comprises a motor for locomotion.

15. The vehicle system of claim 4, wherein the first vehicle includes a first carriage body, wherein the object-handling robot is mounted on the carriage body, and wherein the carriage body further comprises the first support for the at least one container within reach of the robot.

16. The vehicle system of claim 15, wherein the first vehicle further includes a first conveyor system.

17. The vehicle system of claim 16, wherein the second vehicle includes a second carriage body, a second support for the at least one container, a second conveyor section, and an elevator for lifting the at least one container from the second support.
